(19) United States
(12) Patent Application Publication
(10) Pub. No.: US 2007/0273167 A1
(43) Pub. Date: Nov. 29, 2007

(54) Method, system, and apparatus for protecting a vehicle

(76) Inventors: Gail Alexander, Sleepy Hollow, NY (US); Craig Alexander, Sleepy Hollow, NY (US)

Correspondence Address: BUCKLEY, MASCHOFF & TALWALKAR LLC, 50 LOCUST AVENUE, NEW CANAAN, CT, 06840, US

(21) Appl. No.: 11/441,366

(22) Filed: May 25, 2006

(51) Int. Cl. B60R 19/42

(52) U.S. Cl. 293/126

(57) ABSTRACT

A method, system, and apparatus, the apparatus including, in some embodiments, a first elongate member having a resilient front surface, a first clamp located at a first end of the first elongate member, a second elongate member coupled to and adjustably engaged with said first elongate member, the second elongate member having a resilient front surface, a second clamp located at a first end of the second elongate member, a magnetic material connected to a rear surface of the first elongate member and the second elongate member, and a lock mechanism integrated into at least one of the first and the second elongate members to selectively secure a relative position of the coupled and adjustably engaged first and second elongate members.

### BACKGROUND

The present disclosure relates to vehicle protectors. In particular, the present disclosure relates to a method and apparatus to protect a side portion of a vehicle from dents that may be caused by a door of an adjacent vehicle or an errant object such as, for example, a shopping cart.

Modern vehicles, including passenger cars, sport utility vehicles (SUVs), minivans, trucks, and the like typically represent a major investment. Accordingly, a vehicle owner may want to protect such an investment from damage that tends to reduce the value of the vehicle and/or increase the cost of maintaining the vehicle. A common problem encountered by numerous vehicle owners is the occurrence of dents caused by a door of adjacently parked vehicles and other errant objects. It is not uncommon for a vehicle to have a number of dents in the surface metal thereof. The dents may range in size and severity from relatively small “dings” to substantial dents and gouges. In many instances the dents are located on the side of the vehicle, having been caused by, for example, a wayward door parked next to the subject vehicle, a careless parking lot attendant, etc.

In a number of localities parking real estate is at such a premium that parking lot owners, developers, and parking attendants mandate parking vehicles closer than in times past by designating more spots in a given area and/or parking cars closer together than in previous times. It may also be argued by some that people today are less concerned about the damage they may cause by opening their vehicle door into a neighboring vehicle.

In some instances car manufacturers of today have put aesthetics ahead of function to the extent that body molding on the side of current vehicles no longer adequately protect against dents from neighboring cars. In the instance side body molding is present, the body molding may not be adequately located and/or constructed to provide sufficient dent prevention. The side body molding may be provided primarily as a styling garnish. In many instances body side molding is not even incorporated into or onto the side of modern-day vehicles. This is particularly prevalent in a number of high-end or luxury vehicle lines.

Regardless of the cause(s) for dents visited upon vehicles, there exists a need to provide an apparatus and method of easily, conveniently, and efficiently protecting a side portion of a vehicle from other vehicle doors and objects.

### BRIEF DESCRIPTION OF THE DRAWINGS

FIG. 1A is a front view of an exemplary illustration of an apparatus, in accordance with some embodiments herein;

FIG. 1B is a rear view of an exemplary illustration of an apparatus, according to some embodiments herein;

FIG. 2 is an exemplary depiction of an apparatus attached to a vehicle, in accordance with some embodiments herein; and

FIG. 3 is an exemplary flow chart of a method, in accordance with some embodiments herein.

### DETAILED DESCRIPTION

The several embodiments described herein are solely for the purpose of illustration. Embodiments may include any currently or hereafter-known versions of the elements described herein. Therefore, persons skilled in the art will recognize from this description that other embodiments may be practiced with various modifications and alterations.

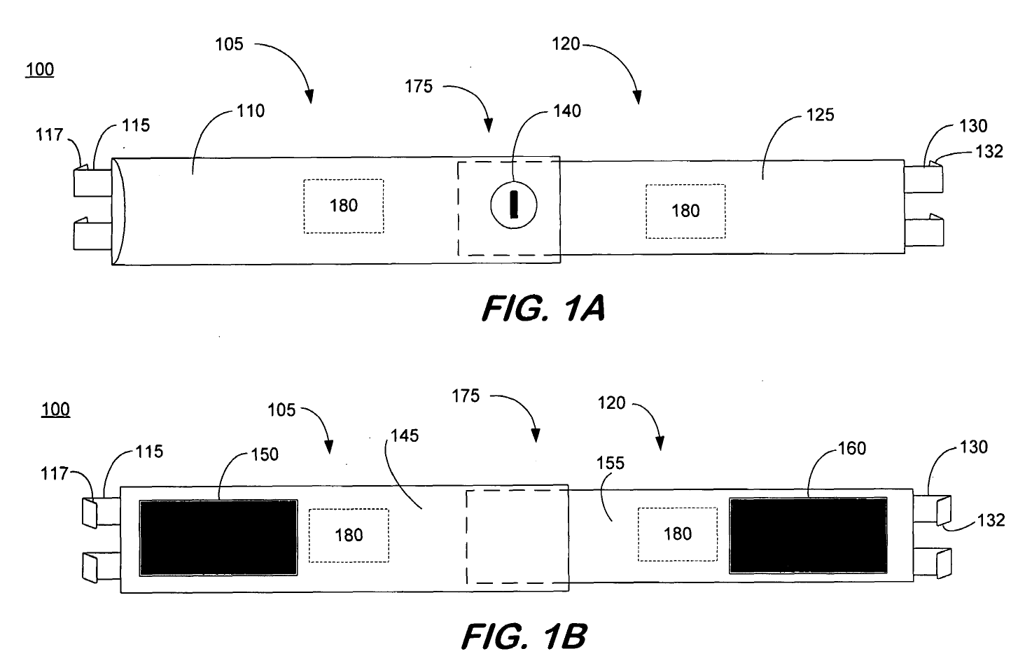

FIG. 1A is a front view of an exemplary depiction of an apparatus or device 100 in accordance with some embodiments herein. Apparatus 100 includes a first elongate member 105 and a second elongate member 120. In some embodiments, elongate members 105 and 120 are connected or coupled together. In some embodiments, elongate members 105 and 120 are adjustably coupled together such that an overall length of apparatus 100 may be selectively varied.

The coupling or connection between elongate members 105 and 120 may be implemented in a number and variety of methods including, for example and not limited to, a sliding friction-fit arrangement, a telescoping arrangement, a ratcheted configuration, a geared arrangement, a stepped adjustment mechanism, a graduated mechanism, a spring or other resistive force adjusting mechanisms, a flexible linkage, and combinations thereof.

It should be appreciated that the aforementioned and other configurations for the coupling or connection between elongate members 105 and 120 may be used in accordance with the present disclosure.

Elongate member 105 includes a front surface 110. Front surface 110 may be a resilient material. In some embodiments, front surface 110 has the properties of being resilient and deformable such that it can withstand a range of impact forces, including those that may be delivered by an opening door of a vehicle. Additionally, the properties of some embodiments of device 100 may include an ability of surface 110 to substantially return to a pre-impact shape. That is, surface 110 has a “memory” and is deformable yet resilient enough to substantially return to its initial shape after absorbing an impact force.

While some embodiments of surface 110 are resilient it should be recognized that there may be a maximum force that surface 110 can be subjected to and retain or return to its initial shape. Above the maximum force surface 110 may not return to the pre-impact shape thereof. However, the maximum may be sufficiently high in some embodiments to cover the typical range of forces delivered by the opening of a vehicle door in close proximity to apparatus 100.

In some embodiments surface 110 and other structural components of apparatus 100 may operate to disperse the impact force. In this manner, a localized impact force to a vehicle behind apparatus 100 may be lessened since the impact force will be dispersed over a larger area and absorbed, at least partially, by apparatus 100.

In some embodiments, surface 110 may be manufactured or painted to match or contrast in color with the color of a vehicle. Apparatus 100 may be manufactured in a variety of finish paint or primer colors. In some embodiments, apparatus 100 may be primed and painted using techniques and procedures consistent with accepted and known automobile industry painting processes.

Second elongate member 120 has a front surface 125. Front surface 125 may be resilient and have properties that are the same as or similar to those discussed hereinabove regarding surface 110. Accordingly, a detailed discussion of surface 125 is not separately provided since a detailed discussion of surface 110 is provided.

Elongate member 105 has a mechanical clamp 115 located at an end thereof. Mechanical clamp 115 may include one or more mechanical devices for attaching to a leading or front edge of a vehicle door. FIGS. 1A and 1B show an exemplary mechanical clamp 115 as including two separate hook-like structures. Mechanical clamp 115 may include a tab 117. Tabs 117 may operate to fit between a leading edge of a vehicle door and a body panel to prevent or impede the removal of elongate member 105 from the door of the vehicle.

In some embodiments mechanical clamp 115 fits between the leading edge of the vehicle door and the body and onto the vehicle door. In this manner elongate member 105 may be mechanically attached to the door of the vehicle.

Elongate member 120 has a mechanical clamp 130 located at an end thereof. Mechanical clamp 130 may include one or more mechanical devices 132 for attaching to a trailing or rear edge of a vehicle door. FIGS. 1A and 1B show an exemplary mechanical clamp 130, including two separate hook-like structures. Mechanical clamp 130 may include a tab 132. Tabs 132 may operate to fit between a trailing or rear edge of a vehicle door and a body panel of a vehicle to prevent or impede the removal of elongate member 120 from the door of the vehicle.

In some embodiments mechanical clamp 130 fits between the trailing edge of the vehicle door and the body and onto the vehicle door. In this manner elongate member 125 may be mechanically attached to the door of the vehicle. That is, mechanical clamp(s) 115, 130 securely and positively grip a vehicle door(s). To maintain attachment to a vehicle door, mechanical clamp(s) 115, 130 need not depend on being trapped or otherwise prevented from being removed from between openings between vehicle doors and/or vehicle body panels.

In some embodiments, mechanical clamps 115 and 130 may differ from each other. The difference in configuration between mechanical clamp 115 and mechanical clamp 130 may be provided to compensate for a difference between a leading edge of a vehicle door and a trailing edge of a door of the vehicle. Differences may account for variations in curvature, clearance distances, and other factors between a leading or trailing edge of a door and an adjoining body panel of the vehicle.

Elongate members 105 and 120 may be adjustably varied relative to each other such that an overall length of apparatus may be selectively varied. Region 175 of apparatus 100 illustrates an exemplary region where elongate members 105 and 120 may overlap as they are adjustably varied.

Apparatus 100 may also include a lock mechanism 140. Lock mechanism 140 may be operated by a key, a code, and combinations thereof. The key may be a mechanical key, a magnetic key, a radio frequency device (e.g., an RFID tag/transponder), a wireless communication device operating using one or more protocols (e.g., Bluetooth®, infrared, etc.), a smart card, and other physical key devices. The code may be physically entered by a user, transmitted by a wireless communication link to lock mechanism 140, based on bio-metrics, and other coded information and code delivery devices and systems.

In some embodiments, lock mechanism 140 is integrated into either elongate member 105 or elongate member 120. In these instances, lock mechanism 140 is physically connected to either elongate member 105 or elongate member 120. In some embodiments, lock mechanism 140 is integrated into both elongate member 105 and elongate member 120 such that lock mechanism 140 is physically connected to both elongate member 105 and elongate member 120.

Lock 140 may operate to secure or fix a relative position of elongate member 105 and elongate member 120. In some embodiments, lock mechanism 140 may be used to selectively secure the relative position of elongate member 105 and elongate member 120. The selectively secured relative position between elongate member 105 and elongate member 120 may be selected such that elongate member 105 and elongate member 120 cannot be removed from the vehicle to which apparatus 100 is attached. That is, lock mechanism 140 and mechanical clamps 115, 130 may cooperate to mechanically attach apparatus 100 to the side of a vehicle.

FIG. 1B shows a rear view of apparatus 100. Elongate member 105 includes a rear surface 145 and elongate member 120 includes a rear surface 155. Rear surfaces 145 and 155 include magnetic material 150 and 160, respectively. Magnetic material 150, 160 may be attached to or incorporated into rear surface 145, 155.

In some embodiments, magnetic material 150, 160 are sufficiently sized and magnetically powerful to support respective ones of elongate member 105 and elongate member 120 in a substantially and relatively fixed location to at least one door of a vehicle by magnetic forces of attraction. Magnetic material 150, 160 may comprise one or more distinct portions of magnetic material (two shown) or, in some embodiments, a unitary segment of magnetic material that extends over at least a portion of elongate member 105 and elongate member 120. In some instances, the magnetic material located on each of elongate members 105, 120 may be more than one distinct sections of magnetic material (not shown) or a unitary section of magnetic material as shown in FIG. 1B.

In some embodiments, including an embodiment where elongate members 105, 120 have resilient front surfaces 110, 125 and rear surfaces 145, 155 including magnetic materials 150, 160, the resilient front surfaces and rear surfaces may reside on a carrier structure constructed of a metal, an alloy, a thermoplastic, and other materials. The carrier material may have the properties of being lightweight, have a high tensile strength, and have a high sheer strength. In some embodiments, an air cavity or other gas filled chamber may be incorporated into elongate members 105, 120 for a number of purposes including, for example, reducing the weight of apparatus 100, providing impact absorption, etc.

In some embodiments, lock mechanism 140 may be associated with one or more other security aspects and systems of a vehicle. For example, lock mechanism 140 may be coupled to a vehicle security system such that the locking and unlocking of apparatus 100 may be effectuated by the arming and disarming of the vehicle's security system. In some embodiments, a single key and/or key fob implemented key mechanism may be used to lock and unlock apparatus 100 and to arm and disarm the vehicle's security system or aspects thereof.

In some embodiments, apparatus 100 may itself provide a measure of theft deterrence. For example, the presence of apparatus 100 locked and securely attached to a vehicle may deter a thief from stealing a vehicle since an attempt to remove door protector by passing lock mechanism 140 may result in damaging the vehicle. In some embodiments, particularly when the apparatus is attached across two doors on the same side of a vehicle, the presence of apparatus 100 locked and securely attached to a vehicle may prevent unauthorized opening of the vehicle doors and entry into the vehicle.

In some embodiments, apparatus 100 may be colored in such a manner as to clearly identify the door protector and further as a theft deterrent. For example, door protector 100 may be painted a high contrast color such as international orange.

In some embodiments, apparatus 100 may have one or more security sensors 180 integrated into, coupled to, associated with, or connected thereto that provide an indication that the door protector is damaged or removed by passing lock mechanism 140. Sensors 180 may be activated by removing door protector from a vehicle without unlocking/disarming lock mechanism 140. Sensor 180 may include a normally open (NO) and a normally closed (NC) mechanism. Sensors 180 may include a number and variety of actuators including, for example, a contact sensor, an impact sensor, a magnetic actuator, a relay, a spring or biased trigger, and other types of actuators. In some embodiments, sensors 180 may sense when one or more of elongate members 105 and 120 sustain at least a threshold impact. Sensors 180 may provide a signal or indication of the impact to a security system, recording device (mechanical or electronic), or an indicator device (e.g., a lamp).

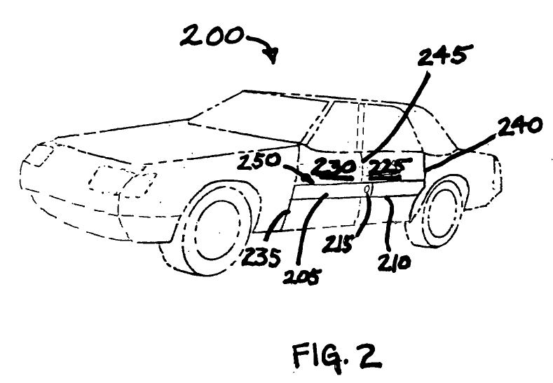

FIG. 2 illustrates an exemplary operation environment to provide a sample context for the present disclosure, including apparatuses and methods. A vehicle 200 is shown having doors 225 and 230. An apparatus, a door protector 250, is attached to doors 225 and 230 to protect the doors from impact damage delivered thereto. Door protector 250 includes a first elongate member 205 and a second elongate member 210 that are adjustably connected to each other. Door protector 250 provides impact protection over the entire length thereof due to the continuity of coverage provided by elongate members 205 and 210.

Door protector 250 attaches to doors 225 and 230 by magnetic material (not shown) attached to a rear surface of elongate members 205 and 210. A mechanical clamp(s) (not shown) attached to a front end of elongate member 205 is positioned between a body panel of vehicle 200 and a leading edge 235 of door 230 and onto door 230 to securely hold at least elongate member 205 to vehicle 200. A mechanical clamp(s) (not shown) attached to a rear end of elongate member 210 is positioned between a body panel of vehicle 200 and a trailing edge 240 of door 225 to securely hold at least elongate member 210 to vehicle 200.

A lock mechanism 215 is provided to selectively and securely lock door protector 250 to doors 225, 230. Lock mechanism 215 is integrated into one or both of elongate members 205 and 210. The integration of lock mechanism into one or both of elongate members 205 and 210 may provide a measure structural integrity, unobtrusive packaging, ease of operation, and other considerations.

It should be appreciated that an exact location of door protector 250 on vehicle 200 may be varied by a user to best suit the particular vehicle and level of protection desired. For example, door protector may be placed above or below a door handle on doors 225, 230.

In some embodiments, door protector 250 may be positioned on one door (225 or 230) of vehicle 200 or on a vehicle having only one door (e.g., a coupe or sports car). For example, a mechanical clamp(s) attached to the front end of elongate member 205 is positioned between a body panel of vehicle 200 and the leading edge 235 of door 230 to securely hold at least elongate member 205 onto door 230 and a mechanical clamp(s) attached to the rear end of elongate member 210 is positioned between a trailing edge of door 230 and a leading edge of door 225 to securely hold at least elongate member 210 onto door 225.

In some embodiments, in accordance with apparatuses and methods hereof, door protector 250 selectively and securely locks to at least one door by a cooperative operation of adjustably varied elongate members 205 and 210, mechanical clamps, and lock mechanism 215. In some embodiments, the clamps mechanically grip or hold onto at least one of doors 225, 230. Elongate members 205 and 210 are adjustably tightened onto ends of the at least one door to secure elongate members 205 and 210 thereto.

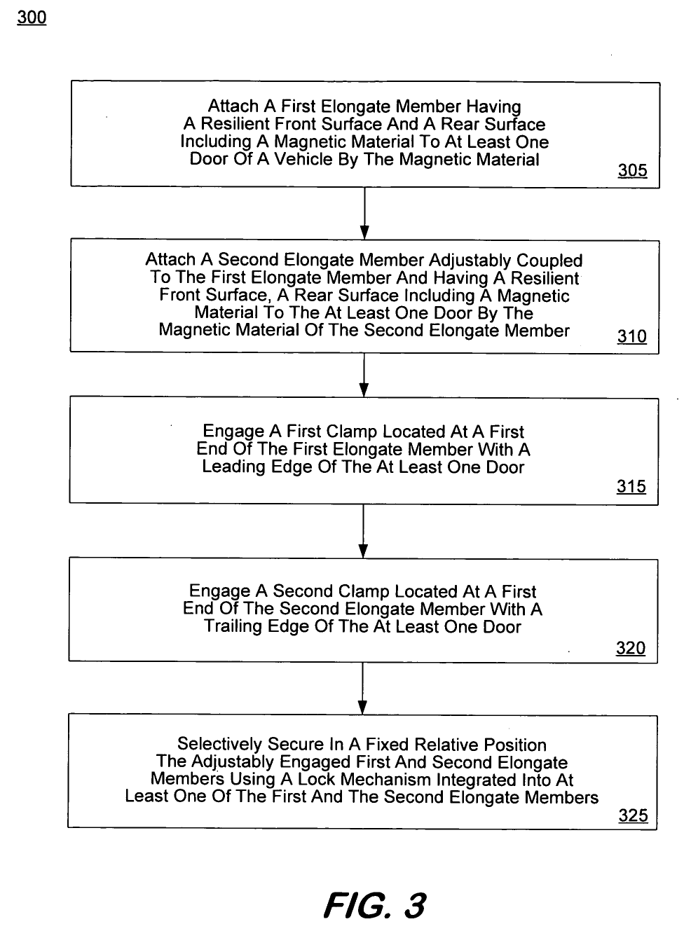

FIG. 3 is a flow diagram of a method 300 in accordance herewith for protecting at least one door of a vehicle. At a first operation 305, a first elongate member having a resilient front surface and a rear surface including a magnetic material is attached to at least one door of a vehicle by the magnetic material.

At operation 310, a second elongate member having a resilient front surface and a rear surface including a magnetic material is attached to the at least one door by the magnetic material of the second elongate member. The second elongate member may be adjustably coupled to the first elongate member.

At operation 315, a first mechanical clamp located at a first end of the first elongate member is engaged with a leading edge of the at least one door. At operation 320, a second mechanical clamp located at a first end of the second elongate member is engaged with a trailing edge of the at least one door.

At operation 325, a lock mechanism is used to selectively secure, in a fixed relative position, the adjustably engaged first and second elongate members to prevent the removal of the first and the second elongate members from the at least one door. In this manner, the at least one door of the vehicle may be efficiently protected from side impact damage.

The foregoing disclosure has been described with reference to specific exemplary embodiments thereof. It will, however, be evident that various modifications and changes may be made thereto without departing from the broader spirit and scope set forth in the appended claims.

What is claimed is:

1. A method, comprising:
attaching a first elongate member having a resilient front surface and a rear surface including a magnetic material to at least one door of a vehicle by the magnetic material;
attaching a second elongate member having a resilient front surface and a rear surface including a magnetic material to the at least one door by the magnetic material of the second elongate member, wherein the second elongate member is adjustably coupled to the first elongate member;
engaging a first mechanical clamp located at a first end of the first elongate member with a leading edge of the at least one door;
engaging a second mechanical clamp located at a first end of the second elongate member with a trailing edge of the at least one door, and
selectively securing in a fixed relative position the adjustably engaged first and second elongate members using a lock mechanism integrated into at least one of the first and the second elongate members to prevent the removal of the first and the second elongate members from the at least one door.

2. The method of claim 1, wherein the at least one door is two doors.

3. The method of claim 1, wherein the resilient material of the first and the second elongate members is sufficiently deformable so as not to damage a door impacting the first and the second elongate members.

4. The method of claim 1, wherein the magnetic material of the first and the second elongate members is sufficient to maintain, by a magnetic force of attraction, the first and the second elongate members in a position as attached to the at least one door.

5. The method of claim 1, wherein, the lock mechanism is integrated into both the first and the second elongate members.

6. The method of claim 1, wherein the lock mechanism is operated by at least one of: a key, a code, and a combination thereof.

7. An apparatus comprising:
a first elongate member having a resilient front surface;
a first mechanical clamp located at a first end of the first elongate member;
a second elongate member coupled to and adjustably engaged with said first elongate member, said second elongate member having a resilient front surface;
a second mechanical clamp located at a first end of the second elongate member,
a magnetic material connected to at least a portion of a rear surface of the first elongate member and at least a portion of a rear surface of the second elongate member; and
a lock mechanism integrated into at least one of the first and the second elongate members to selectively secure in a fixed relative position the adjustably engaged first and second elongate members.

8. The apparatus of claim 7, wherein the at least one door is two doors.

9. The apparatus of claim 7, wherein the resilient material of the first and the second elongate members is sufficiently deformable so as not to damage a door impacting the first and the second elongate members.

10. The apparatus of claim 7, wherein the lock mechanism is integrated into both the first and the second elongate members.

11. The apparatus of claim 7, wherein the lock mechanism is operated by at least on of: a key, a code, and a combination thereof.

12. The apparatus of claim 7, wherein the magnetic material is sufficient to magnetically hold the first and the second elongate members to the at least one door and the first mechanical clamp and the second mechanical clamp prevent the first and the second elongate members from being removed from the at least one door.

13. The apparatus of claim 7, further comprising at least one sensor of the type selected from the group of: an impact sensor and a security sensor.

14. An apparatus to attach to a side of a vehicle to provide protection of at least one door of the vehicle, the apparatus comprising:
a first elongate member having a resilient front surface and a rear surface including a magnetic material;
a first mechanical clamp located at a first end of the first elongate member to connect to a leading edge of the at least one door;
a second elongate member coupled to and adjustably engaged with said first elongate member, said second elongate member having a resilient front surface and a rear surface including a magnetic material;
a second mechanical clamp located at a first end of the second elongate member to connect to a trailing edge of the at least one door, and
a lock mechanism integrated into at least one of the first and the second elongate members to selectively secure in a fixed relative position the coupled and adjustably engaged first and second elongate members.

15. The apparatus of claim 14, wherein the at least one door is two doors.

16. The apparatus of claim 14, wherein the resilient material of the first and the second elongate members is sufficiently deformable so as not to damage a door impacting the first and the second elongate members.

17. The apparatus of claim 14, wherein the lock mechanism is integrated into both the first and the second elongate members.

18. The apparatus of claim 14, wherein the lock mechanism is operated by a key, a code, and a combination thereof.

19. The apparatus of claim 14, wherein the magnetic material is sufficient to magnetically hold the first and the second elongate members to the at least one door and the first mechanical clamp and the second mechanical clamp prevent the first and the second elongate members from being removed from the at least one door.

20. The apparatus of claim 14, further comprising at least one sensor of the type selected from the group of: an impact sensor and a security sensor.
